(19) United States
(12) Patent Application Publication
(10) Pub. No.: US 2004/0192301 A1
(43) Pub. Date: Sep. 30, 2004

(54) Systems and techniques for originating calls in multi-mode network environments

(76) Inventor: Guangming Shi, San Diego, CA (US)

Correspondence Address: Qualcomm Incorporated, Patents Department, 5775 Morehouse Drive, San Diego, CA, 92121-1714, US

(21) Appl. No.: 10/211,022

(22) Filed: Aug. 1, 2002

(51) Int. Cl. H04Q 7/20

(52) U.S. Cl. 455/435.1; 455/414.1

(57) ABSTRACT

Systems and techniques are disclosed relating to communications. The systems and techniques include initiating a call origination request having a service parameter, and originating a call over a network selected from a plurality of networks as a function of the service parameter. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND

1. Field

The present invention relates to systems and techniques for originating calls in multi-mode network environments.

2. Background

The demand for wireless services has led to the development of an ever increasing number of wireless networks. One such network is a CDMA 1X (Code-Division Multiple Access) system which supports wireless voice and data services using spread-spectrum techniques. A competing network which has become the de facto standard in Europe and Asia is GSM (Global System for Mobile Communications). Unlike CDMA 1X, GSM uses narrowband TDMA to support wireless voice and data services. Other networks that have evolved over the years include CDMA 1xEV-DO for high speed data services based on spread-spectrum technology, GPRS (General Packet Radio Service) which supports high speed data services with data rates suitable for e-mail and web browsing applications, and UMTS (Universal Mobile Telecommunications System) which can deliver broadband voice and data for audio and video applications.

In general, communications devices that are compatible with one wireless network are incompatible with other wireless networks. This is due, in part, to each network's use of its own unique protocols for communicating between compatible communications devices. In addition, each wireless network may have its own unique set of services. For example, CDMA 1X, GSM and UMTS support both wireless voice and data services whereas CDMA 1xEV-DO and GPRS are limited to wireless data services. Even wireless networks that support the same services may not be compatible with one another due to different operating parameters. For example, GSM and GPRS both support data services, however, GPS typically supports data rates of 9.6 kilobits per second (kbits/s) while GPRS may support speeds up to 115 kbits/s.

These disparate networks have created a series of islands of wireless service throughout the geographic landscape, each with its own unique set of protocols, services, and data rates. Yet conventional communications devices are ill-equipped to deal with these disparate networks. Accordingly, there is a need for a methodology wherein a user can communicate with different wireless networks in a simple and efficient manner. The specific methodology should provide automatic selection of the wireless network that can best support the user's call.

### SUMMARY

In one aspect of the present invention, a method of communications includes initiating a call origination request having a service parameter, and originating a call over a network selected from a plurality of networks as a function of the service parameter.

In another aspect of the present invention, computer readable media embodying a program of instructions executable by a computer program is capable of performing a method of communications, the method including initiating a call origination request having a service parameter, and originating a call over a network selected from a plurality of networks as a function of the service parameter.

In yet another aspect of the present invention, a communications device includes an input device configured to initiate a call origination request having a service parameter, and originate a call over a network selected from a plurality of networks as a function of the service.

In a further aspect of the present invention, a communications device includes means for initiating a call origination request having a service parameter, and means for originating a call over a network selected from a plurality of networks as a function of the service parameter.

It is understood that other embodiments of the present invention will become readily apparent to those skilled in the art from the following detailed description, wherein it is shown and described only exemplary embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings wherein:

FIG. 1 is a functional block diagram of an exemplary hardware configuration to support a software based processor system operating in a multi-mode wireless communications device;

FIG. 2 is a top view of an exemplary communications device with a display presenting a sub-menu selection screen;

FIG. 3 is a functional block diagram of an exemplary multi-layer software architecture for the software based processor system of FIG. 1; and

FIG. 4 is a flow diagram showing the function of an exemplary call manager operating within the multi-layer software architecture of FIG. 3.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

An exemplary wireless communications device such as a cellular telephone or similar device can be used to communicate with various wireless networks. Access to these networks can be managed by the device in a way that is transparent to the user. More specifically, the communications device can automatically designate the wireless network that can best support the user's call without the user needing to know which network is being used. The manner in which the wireless network is designated may vary from device to device, and those skilled in the art will readily be able determine the selection criteria best suited for the particular application. In one embodiment of the communications device, an algorithm or similar methodology can be used to determine the service compatibility of various wireless networks based on the call origination request by the user or the call origination request by an application such as a browser. The automatic selection of the compatible wireless network can then be made based on user preferences. The user preferences can be programmed into the communications device by the user before making the call. Alternatively, the user preferences can set by the manufacturer at the factory or by the carriers, phone service or sales outlet before sale. Virtually any algorithm could be implemented to manage access to the various wireless networks. This concept can be extended to other wireless technologies including any satellite or terrestrial application.

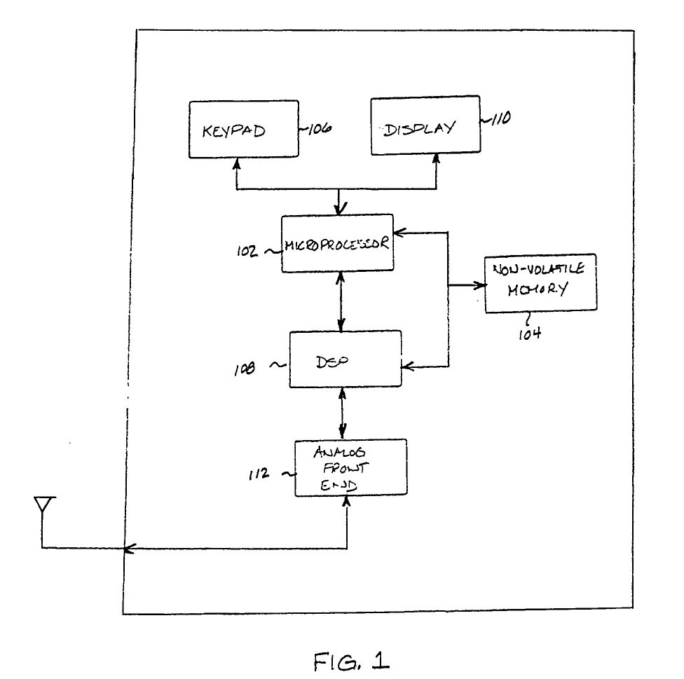

Network access in a wireless communications device can be managed with a software based processor system, or any other configuration known in the art. An exemplary hardware configuration for a software based processor system is shown in FIG. 1. The processor system has a microprocessor 102 at its core with non-volatile memory 104. The microprocessor 102 can provide a platform to run software programs that, among other things, manage access to various networks based on (1) the service compatibility of those networks with the call originated by the user, and (2) the preferences of the user which can be programmed into the non-volatile memory 104.

A digital signal processor (DSP) 108 can be implemented with an embedded communications software layer which runs application specific algorithms to reduce the processing demands on the microprocessor 102. For example, during call origination, the DSP 108 can be used to provide encoding and modulation of text messages from the keypad 106 before those text messages are transmitted to a far end user through an analog front end 112. The DSP 108 can also provide decoding and demodulation of text messages from the far end user received through the analog front end 112 before presentation to a display 110. The software layer also interfaces the DSP hardware to the microprocessor 102 and may provide low level services such as allocation of resources to allow the higher level software programs to run.

The exemplary processor system supports user entry and editing functions. The user interface can be fully menu driven or implemented in any other fashion. In the menu driven user interface, on-screen options can be presented to display 110 in the form of a main menu for programming the communications device. From the main menu, the user can select an on-screen option for programming user network preferences through various keypad manipulations. Once this on-screen option is selected by the user, the microprocessor 102 retrieves a list of networks from the non-volatile memory 104 and presents the list to the display 114 in a sub-menu format. The sub-menu may contain a list of all networks supported by the communications device, or alternatively can display a list of networks for voice services separately from data services.

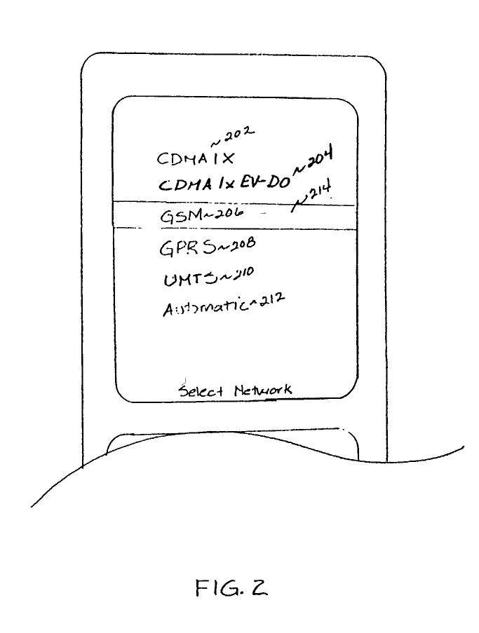

A sub-menu format is shown in FIG. 2 with a list of all networks supported by an exemplary communications device. In this example, CDMA 1X 202, CDMA 1xEV-DO 204, GSM 206, GPRS 208 and UMTS 210 are supported, however, any combination of networks may be supported depending on the communications environment and the overall design constraints. The sub-menu list may also include an Automatic entry 212 which, if selected by the user, will result in the automatic selection of wireless networks by the communications device. With this sub-menu format, the user can program his or her preferred network by positioning a cursor 214 over the preferred network listing with the keypad 106 and depressing an enter key (not shown). As a result, the microprocessor 102 will store data relating to the preferred network in the non-volatile memory 104. Once the preferred network is stored, the microprocessor 102 may prompt the user through a series of display messages to select a second, or even a third, preferred network. Should the preferred network selected by the user support data services only, the microprocessor 102 may prompt the user to select a preferred network for voice services. Conversely, if the preferred network selected by the user supports voice services only, the microprocessor 102 may prompt the user to select a preferred network for data services. As those skilled in the art will readily appreciate, the potential menu options and sequences that can be implemented are unlimited.

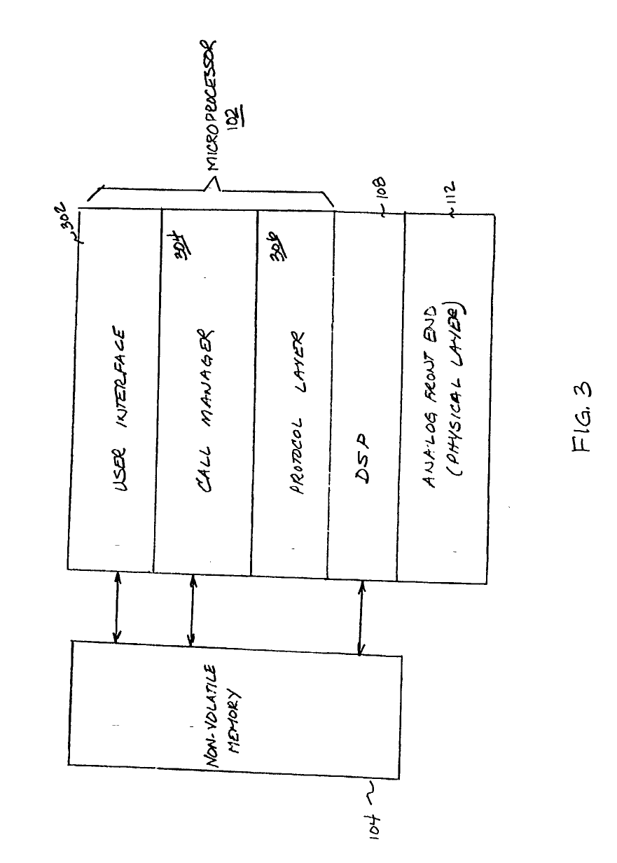

An exemplary microprocessor multi-layer software architecture is shown in FIG. 3. The software architecture includes a user interface 302, a call manager 304 and a protocol layer 306 running on a microprocessor platform. The DSP 108 and analog front end 112 are shown for completeness, but will not be discussed further. Alternatively, each software layer can be run on separate processors or any combination of processors. The processors can be internal to the communications device, or alternatively, one or more processors could be located in an external device such as a laptop computer connected to the communications device. As those skilled in the art will appreciate, the implementation details may vary depending on the particular communications application and the overall design constraints.

The primary function of the user interface 302 is to bring structure to the interaction between the user and the communications device. During the programming of user network preferences, the user interface 302 is responsible for generating the menu and sub-menus presented to the display from data stored the non-volatile memory 104. The user interface 302 is also for responsible deleting, adding and reordering user preferred networks within the non-volatile memory 104 in response to menu and sub-menu selections.

The user interface 302 is a software program, or set of programs, that sits as a layer above the call manager 304. The software programs can be applications such as phone book, SMS, browser, e-mail, or any other software programs. When the user originates a call, or launches an application that initiates a call, the user interface 302 determines the service parameters of the call from the keypad entries. The service parameters typically include, among other things, the type of service requested. For example, the requested service can be a voice call, a data call, or any other service provided by the carrier. The user interface 302 may also include other service parameters such as the quality of service needed to support the call. For example, if the user initiates a video application, the user interface 202 may determine that the call requires a data rate of 64 kbits/s or higher.

The call manager 204 can be used to manage access to various networks in a way that is transparent to the user. Based on the service parameters derived from the user's call origination request, the call manager 204 determines the service compatibility of all the networks supported by the communications device. For example, if the communications device supports CDMA 1X, CDMA 1xEV-DO, GSM, GPRS, and UMTS networks, and the service requested is a video application, the call manager 204 may determine that only the CDMA 1xEV-DO and UMTS networks can support this application. In that event, the call manager 204 will select one of the two compatible networks to service the call. The selection criteria can be based on any algorithm. In the exemplary communications device described thus far, the selection criteria is based on user network preferences programmed in the non-volatile memory 104. If one or more of the user network preferences is among the compatible networks, the call manager 204 will attempt to register the communications device with the users first choice. If, on the other hand, none of the user network preferences are found among the compatible networks, then the call manager 204 may invoke other selection criteria such as cost, bandwidth, network traffic, or any other criteria to select a network. In any event, once the call manager 204 selects a network, a registration request can be sent from the communications device via the protocol layer 206 in the protocol format of the selected network. The protocol layer 206 can also be used to provide protocol independent responses from the selected network to the call manager 204.

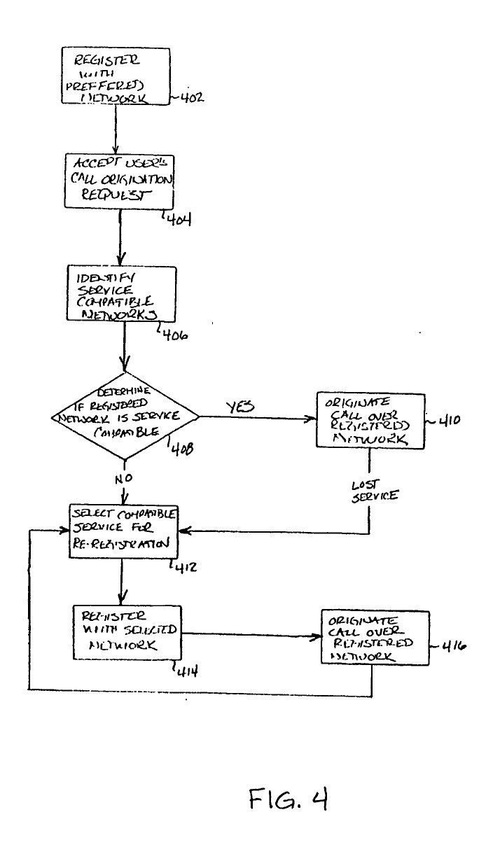

FIG. 4 is a flow diagram showing the operation of the call manager. When power is first applied to the communications device, the call manager may attempt to register with the user preferred network stored in non-volatile memory in step 402. Once registered, the call manager accepts a call origination request from the user through the user interface in step 404. The call origination request includes various service parameters such as the type of service requested by the user and the quality of service needed to support the call. In step 406, the call manager identifies the networks supported by the communications device that are service compatible with the call origination request. In step 408, the call manager determines whether the registered network is among the service compatible networks. If the registered network is among the service compatible networks, then the call manager attempts to originate a call on that network in step 410. If the registered network is not among the service compatible networks, or if the service for the registered network is lost, then the call manager selects one of the service compatible networks for re-registration in step 412. In that case, the call manager first determines whether any other user network preferences are stored in the non-volatile memory, and if so, determines whether any of those networks are among the service compatible networks. If more than one of those networks are stored in the non-volatile memory, then the call manager will select one of those networks based on the relative preferences between those networks preprogrammed by the user. If, on the other hand, none of the user preferred networks are among the service compatible networks, then some other selection criteria will be used to select a network. In any event, once an alternative network is selected, the call manager will de-register the communications device from the current network and attempt to register with the new selected network in step 414. If the call manager is unsuccessful in registering the communications device with the new selected network, the call manager will select another network for registration among the service compatible networks in step 412 based on the user network preferences stored in the non-volatile memory, or some other selection criteria. If the communications device is successfully registered with the selected network, the call manager will attempt to originate a call over that network in step 416.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of communications, comprising:
initiating a call origination request having a service parameter;
originating a call over a network selected from a plurality of networks as a function of the service parameter.

2. The method of claim 1 further comprising designating a network from the plurality of networks, the network selected for originating the call being the designated network if the designated network can support the service parameter.

3. The method of claim 2 wherein the designated network is designated by a user before the call is originated.

4. The method of claim 2 further comprising designating a second network from the plurality of networks, the network selected for originating the call being the second designated network if the designated network cannot support the service parameter and the second designated network can support the service parameter.

5. The method of claim 2 further comprising designating a group of networks from the plurality of networks, and ordering the designated networks by preference, the network selected for originating the call being the highest preference designated network that can support the service parameter.

6. The method of claim 2 further comprising registering with the designated network before receiving the call origination request.

7. The method of claim 6 wherein the network selected for originating the call is not the designated network, the method further comprising deregistering with the designated network and registering with the network selected for originating the call.

8. The method of claim 2 further comprising identifying each of the networks that can support the service parameter, wherein the network selected for originating the call is the designated network if the designated network is one of the identified networks.

9. The method of claim 1 wherein the service parameter relates to information content.

10. The method of claim 9 wherein the information content comprises voice.

11. The method of claim 9 wherein the information content comprises data.

12. The method of claim 1 wherein the call origination request comprises a second service parameter, the network for originating the call being selected as a function of both the service parameter and the second service parameter.

13. The method of claim 12 wherein the service parameter relates to information content and the second service parameter comprises data rate.

14. Computer readable media embodying a program of instructions executable by a computer program to perform a method of communications, the method comprising:
generating a call origination request having a service parameter;
originating a call over a network selected from a plurality of networks as a function of the service parameter.

15. The computer readable media of claim 14 wherein the method further comprises designating a network from the plurality of networks, the network selected for originating the call being the designated network if the designated network can support the service parameter.

16. The computer readable media of claim 15 wherein the designated network is designated by a user before the call is originated.

17. The computer readable media of claim 15 wherein the method further comprises designating a second network from the plurality of networks, the network selected for originating the call being the second designated network if the designated network cannot support the service parameter and the second designated network can support the service parameter.

18. The computer readable media of claim 15 wherein the method further comprises designating a group of networks from the plurality of networks, and ordering the designated networks by preference, the network selected for originating the call being the highest preference designated network that can support the service parameter.

19. The computer readable media of claim 15 wherein the method further comprises registering with the designated network before receiving the call origination request.

20. The computer readable media of claim 19 wherein the network selected for originating the call is not the designated network, the method further comprising deregistering with the designated network and registering with the network selected for originating the call.

21. The computer readable media of claim 15 wherein the method further comprises identifying each of the networks that can support the service parameter, wherein the network selected for originating the call is the designated network if the designated network is one of the identified networks.

22. The computer readable media of claim 14 wherein the service parameter relates to information content.

23. The computer readable media of claim 22 wherein the information content comprises voice.

24. The computer readable media of claim 22 wherein the information content comprises data.

25. The computer readable media of claim 14 wherein the call origination request comprises a second service parameter, the network for originating the call being selected as a function of both the service parameter and the second service parameter.

26. The computer readable media of claim 25 wherein the service parameter related to information content and the second service parameter comprises data rate.

27. A communications device, comprising:
a input device configured to initiate a call origination request having a service parameter; and
a processor configured to originate a call over a network selected from a plurality of networks as a function of the service parameter.

28. The communications device of claim 27 further comprising memory configured to store data relating to a designated network from the plurality of networks, the processor being further configured to select the designated network to originate the call if the designated network can support the service parameter.

29. The communications device of claim 28 wherein the memory is further configured to store data relating to a second designated network from the plurality of networks, the processor being further configured to select the second designated network to originate the call if the designated network cannot support the service parameter and the second designated network can support the service parameter.

30. The communications device of claim 28 wherein the memory is further configured to store data relating to a group of designated networks from the plurality of networks, and wherein the data relating to the designated networks are ordered by preference, the processor being further configured to select the highest preference designated network that can support the service parameter to originate the call.

31. The communications device of claim 28 the input device is further configured to allow a user to select the designated network from the plurality of networks.

32. The communications device of claim 31 wherein the input device comprises a keypad.

33. The communications device of claim 31 wherein the memory is further configured to store data relating to each of the networks, the communications device further comprising a display configured to display the data relating to each of the networks to facilitate the selection of the designated network from the plurality of networks with the input device.

34. The communications device of claim 28 wherein the processor is further configured to identify each of the networks that can support the service parameter, and select the designated network to originate the call if the designated network is one of the identified networks.

35. The communications device of claim 28 wherein the processor is further configured to register with the designated network before receiving the call origination request.

36. The communications device of claim 35 the processor is further configured to deregister with the designated network if the network selected by the processor for originating the call is not the designated network.

37. The communications device of claim 36 wherein the processor is further configured to register with the network selected for originating the call.

38. The communications device of claim 27 wherein the service parameter relates to information content.

39. The communications device of claim 38 wherein the information content comprises voice.

40. The communications device of claim 38 wherein the information content comprises data.

41. The communications device of claim 27 wherein the call origination request comprises a second service parameter, the processor further being configured to select the network to originate the call as a function of both the service parameter and the second service parameter.

42. The communications device of claim 41 wherein the service parameter related to information content and the second service parameter comprises data rate.

43. A communications device, comprising:
means for initiating a call origination request having a service parameter; and
means for originating a call over a network selected from a plurality of networks as a function of the service parameter.

44. The communications device of claim 43 further comprising means for designating a network from the plurality of networks, wherein the means for originating the call includes means for selecting the designated network for originating the call if the designated network can support the service parameter.

45. The communications device of claim 44 further comprising means for designating a second network from the plurality of networks, wherein the means for originating the call comprises means for selecting the second designated network for originating the call if the if the designated network cannot support the service parameter and the second designed network can support the service parameter.

46. The communications device of claim 44 wherein the means for designating a network comprises memory having data relating to each of the networks stored therein, a display configured to display the data for each of the networks stored in the memory, a keypad configured to select the displayed data for one of the networks as the designated network, and means for storing data in the memory relating to the designated network.

47. The communications device of claim 44 further comprising means for identifying each of the networks that can support the service parameter, wherein the means for originating the call includes means for selecting the designated network if the designated network is one of the identified networks.

48. The communications device of claim 44 further comprising means for registering the designated network before receiving the call origination request.

49. The communications device of claim 48 further comprising means for deregistering with the designated network if the designated network cannot support the service parameter.

50. The communications device of claim 49 further comprising means for registering with the network selected for originating the call.

51. The communications device of claim 43 further comprising means for designating a group of networks from the plurality of networks, and means for ordering the designated networks by preference, wherein the means for originating the call comprises means for selecting the highest preference designated network that can support the service parameter.

52. The communications device of claim 43 wherein the service parameter relates to information content.

53. The communications device of claim 52 wherein the information content comprises voice.

54. The communications device of claim 52 wherein the information content comprises data.

55. The communications device of claim 43 wherein the call origination request comprises a second service parameter, and wherein the means for originating the call includes means for selecting the network for originating the call as a function of both the service parameter and the second service parameter.

56. The communications device of claim 45 wherein the service parameter relates to information content and the second service parameter comprises data rate.
